(19) United States
(12) Patent Application Publication
(10) Pub. No.: US 2012/0179504 A1
(43) Pub. Date: Jul. 12, 2012

(54) P2P WORKFLOW SYSTEM, INFORMATION PROCESSING APPARATUS AND STORAGE MEDIUM

(76) Inventor: Hirofumi NAKASHIMA, Tokyo (JP)

(21) Appl. No.: 13/427,238

(22) Filed: Mar. 22, 2012

Related U.S. Application Data
(63) Continuation of application No. PCT/JP2009/067515, filed on Oct. 7, 2009.

(51) Int. Cl. G06Q 10/06

(52) U.S. Cl. 705/7.14; 705/7.13

(57) ABSTRACT

Provided is a work flow system configured by a plurality of process support tools cooperating via a network. A process support tool serves as a parent to constitute a group and defines a work flow (process) formed by roles of respective members of the group and a plurality of tasks. Each of the members of the group executes the process while specifying a processor of the next task in accordance with the defined member role and distributes a message containing the processing result between the members one after another.

### CROSS REFERENCE TO RELATED APPLICATIONS

This application is a Continuation Application of PCT Application No. PCT/JP2009/067515, filed Oct. 7, 2009, the entire contents of which are incorporated herein by reference.

### BACKGROUND OF THE INVENTION

1. Field of the Invention

The present invention relates to a workflow system configured to support a series of work in, for example, a company or the like, constituted of a plurality of processes, and processed through a plurality of operators.

2. Description of the Related Art

With the spread of personal computers (PCs), and improved maintenance of the network environment and the like, computerization of work is widely attempted in many companies. The workflow system is known as a method for supporting the computerization in order that the work can be efficiently carried out by the computerization.

In general, in the workflow system, the progress of work or the like is unitarily managed by a server, and operators of each process carry out the work in the charge of the operators on a timely basis by using PCs network-connected to the server. Further, regarding this workflow system, various proposals have hitherto been propounded (see, for example, Jpn. Pat. Appin. KOKAI Publication No. 2008-117258 or the like).

### BRIEF SUMMARY OF THE INVENTION

### Problem to Be Solved

At present, in a general server-type workflow system, when a process (workflow) is to be formed between users who are not accommodated in the same system, the formation of the process is dealt with by re-accommodating the users in the same system or by connecting the systems in which the users are accommodated to each other. However, in this case, there is a problem that preparation of a system for accommodation, adjustment of system administrators or the connection work requires much labor and time.

Further, at present, in the general server-type workflow system, since processes or tasks are managed by the server, in order to connect, to each other, processes provided from different systems or to make the processes to cooperate with each other, there is a problem that adjustment between administrators of the systems is required, and thereafter connection work such as system renovation should be carried out, thereby requiring much labor and time (each of the administrators in this case also has a role of being responsible for improvement of the system). Further, it is common that much labor and time are required of the administrator for the purpose of process improvement in the case of renovation of a process provided by the same system.

As a result, in order to maximize the effect per unit management cost, there are not a few cases where the support range of the system is narrowed down to the standard process for total optimization, and work processes of minor details outside the narrowing are disposed outside the system by electronic mail, spreadsheet tools or the like or by adjusting the work processes to the structure of the system to be disposed. When a plurality of systems utilized by a user are not connected to each other, there is even a case where the user is forced to mediate between different processes by carrying out, for example, double effort in such a manner that as if the mediation is carried out by another self of the user formed for each system. Further, there are not a few cases where even with a work process supported by a system, renovation of the system cannot follow the change in the environment surrounding the work, the work is processed by electronic mail or spreadsheet tools, and data entry into the system is carried out thereafter.

The present invention has been contrived in consideration of these circumstances, and an object thereof is to provide a workflow system, information processing apparatus and storage medium enabling an operation which can be improved by parties who are interested in process improvement without burdening system administrators with labor.

### Means for Solving the Problem

In order to achieve the aforementioned object, a workflow system of the present invention is a workflow system for processing a process constituted of a plurality of tasks in sequence by a plurality of workflow support modules which are incorporated in one or more computers and to each of which at least one of the plurality of tasks is assigned. Each of the plurality of workflow support modules includes a group creation unit configured to create a group while defining a role of each of the plurality of workflow support modules to be affiliated with the group as members, a process definition unit configured to define a process constituted of a plurality of tasks while designating roles of members to be in charge of the tasks, and a process processing unit configured to process tasks in the process defined by the process definition unit, and to transfer a message to a workflow support module in which a role to be in charge of the next task is defined based on the defined role. The message includes information indicating a processing result and a progress situation of each task concerning the process. The group creation unit is capable of creating a new group in a state where a workflow support module thereof is affiliated with an existing group and creating a new group with which another workflow support module affiliated with an existing group as a member is affiliated as a member.

### Advantage of the Invention

According to the present invention, an operation which can be improved by parties who are interested in process improvement without burdening system administrators with labor is enabled.

### BRIEF DESCRIPTION OF THE SEVERAL VIEWS OF THE DRAWING

FIG. 1 is a view showing an operating environment of a workflow system according to an embodiment of the present invention.

FIG. 2 is a view for explaining the configuration of a group formed in the workflow system of the embodiment.

FIG. 3 is a view showing functional blocks of a process support tool (workflow support program) configured to realize the workflow system of the embodiment.

FIG. 4 is a view showing a configuration example of utilization permission information used in the workflow system of the embodiment.

FIG. 5A is a first view for explaining a configuration example of member information used in the workflow system of the embodiment.

FIG. 5B is a second view for explaining the configuration example of member information used in the workflow system of the embodiment.

FIG. 6A is a first view for explaining a configuration example of link information used in the workflow system of the embodiment.

FIG. 6B is a second view for explaining the configuration example of link information used in the workflow system of the embodiment.

FIG. 7 is a view showing a configuration example of affiliation permission information used in the workflow system of the embodiment.

FIG. 8A is a first view for explaining a configuration example of a process defined in the workflow system of the embodiment.

FIG. 8B is a second view for explaining the configuration example of a process defined in the workflow system of the embodiment.

FIG. 9 is a conceptual view for explaining the principle of processing in which a plurality of process support tools process a process in cooperation with each other in the workflow system of the embodiment.

FIG. 10 is a flowchart showing an example of a processing procedure of a process (message) in the workflow system of the embodiment.

FIG. 11 is a view showing an example of a work screen to be presented in the workflow system of the embodiment.

FIG. 12 is a conceptual view for explaining an example of a procedure for adding processing result information to a message in the workflow system of the embodiment.

FIG. 13 is a view showing an example of a message to which processing result information is added one after another.

FIG. 14 is a view for explaining an example in which a plurality of processes are made to cooperate with each other in the workflow system of the embodiment.

FIG. 15 is a view for explaining an example in which an edit item of a certain process is fractionalized by another process in the workflow system of the embodiment.

### DETAILED DESCRIPTION OF THE INVENTION

Hereinafter, an embodiment of the present invention will be described below with reference to the drawings.

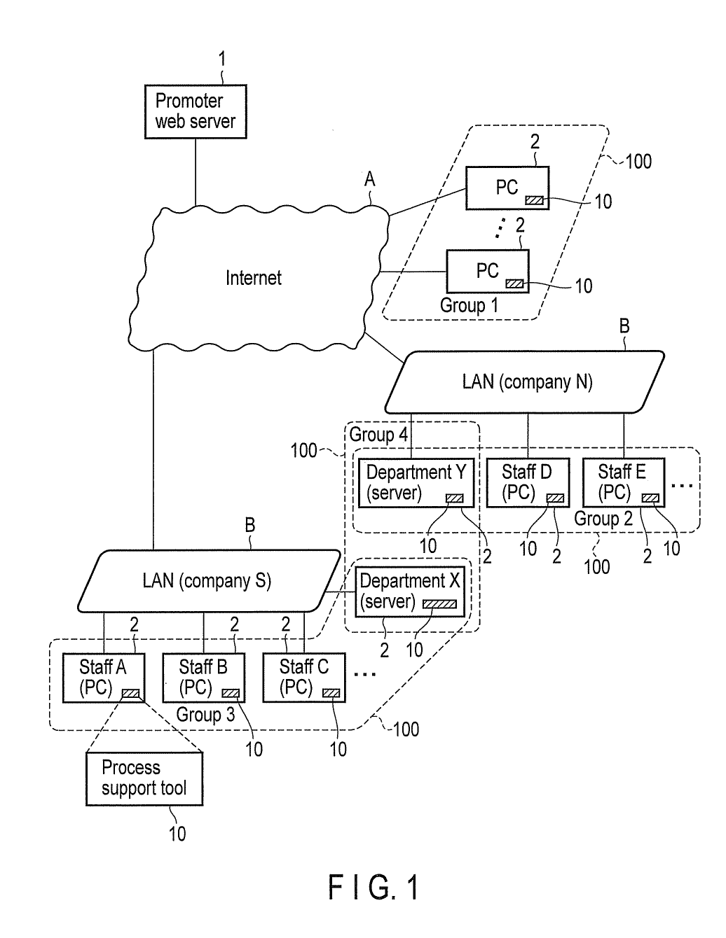

FIG. 1 is a view showing an example of an environment in which a workflow system according to an embodiment of the present invention operates.

This workflow system is realized by a plurality of process support tools 10 (workflow support programs) each installed in computers 2 such as PCs, servers and the like operating in cooperation with each other through networks (A, B). The process support tool 10 is a program to be acquired by, for example, being recorded on an optical disc (OD) or the like which can be read by the computer 2, and being distributed or by being downloaded from a promoter web server 1.

The promoter web server 1 is a web server established by a distributor (promoter) of the process support tool 10, and a utilization-wisher (user) of the process support tool 10 applies to the promoter web server 1 for utilization permission through the Internet, and acquires the utilization permission information. The utilization permission information includes information which will be needed by the process support tool 10 to realize the workflow system in cooperation with other process support tools 10, and details thereof will be described later.

This workflow system is a P2P workflow system, in which process support tools 10 that have acquired utilization permission information from the promoter web server 1 form a group 100, whereby it is made possible to appropriately define and operate a process (workflow) coming/going by way of the users of the process support tools 10. In the example of FIG. 1, a group 100 is formed by a plurality of PCs through the Internet A (group 1), and further, a group 100 is formed by a server and PCs on a LAN (B) laid on the premises of company N (group 2). Likewise, a group 100 is formed by a server and PCs on a LAN (B) laid on the premises of company S (group 3). Furthermore, a group 100 is formed by servers of company N and company S (group 4). As described above, formation of a group 100 by process support tools 10 is not limited by the situation of the installation site on which the computer 2 is placed in the least.

It should be noted that in FIG. 1, although an example in which each user uses a computer 2, and a process support tool 10 is installed in the computer 2 of each user is shown, this workflow system is not limited to this form and, for example, when one computer 2 is used in common by a plurality of users, by implementing process support tools 10 of the number of users in the one comport 2, it is also possible for the users using the one computer 2 in common to utilize this workflow system.

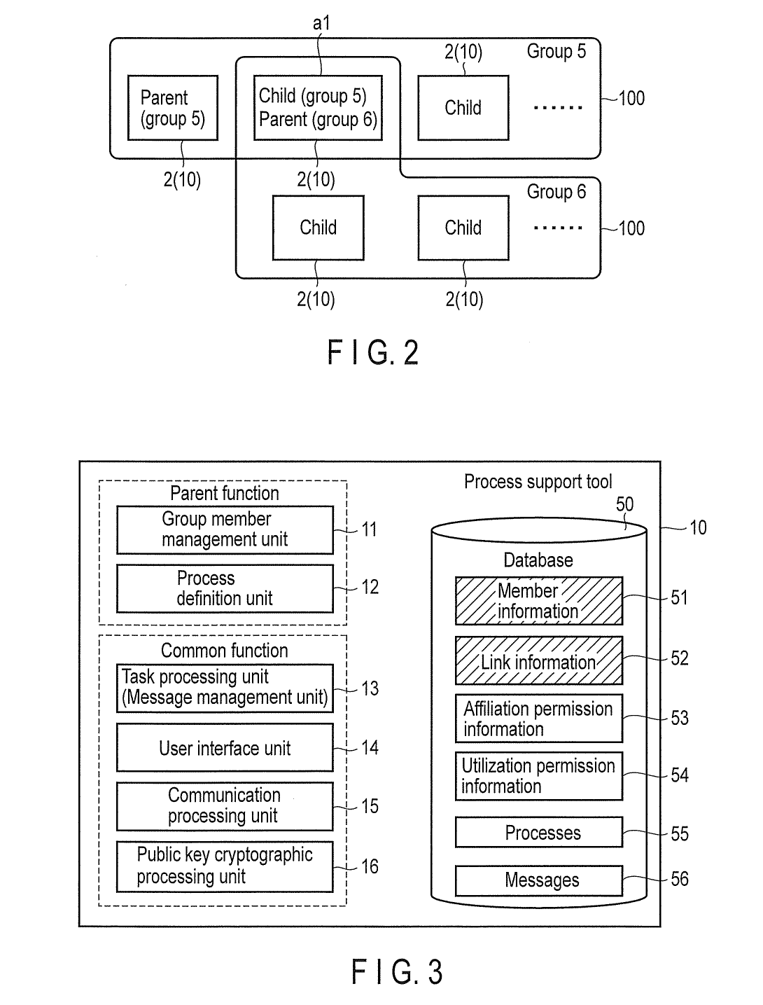

FIG. 2 is a view for explaining the configuration of a group 100 formed by a plurality of process support tools 10 (each of which is installed in a computer 2) configured to realize this workflow system.

As shown in FIG. 2, in group 100 formed in the workflow system, one of the process support tools 10 constituting group 100 bears a role of a parent, and the process support tools 10 other than the parent process support tool 10 bear roles of children. Further, each process support tool 10 can be affiliated with a plurality of groups 100. In the example shown in FIG. 2, the process support tool 10 (al in FIG. 2) taking part in group 5 as a child constitutes group 6 as a parent. That is, each of the process support tools 10 has both a parent function configured to form a group 100 as a parent, and child function configured to take part in a group 100 as a child.

FIG. 3 is a view showing functional blocks of a process support tool 10 configured to realize the workflow system.

As shown in FIG. 3, the process support tool 10 includes a group member management unit 11, process definition unit 12, task processing unit 13, user interface unit 14, communication processing unit 15, public key cryptographic processing unit 16 and the like. Among these, the group member management unit 11 and process definition unit 12 are modules provided to realize the parent function, and the task processing unit 13, user interface unit 14, communication processing unit 15 and public key cryptographic processing unit 16 are modules provided to realize a common function (having no relation with the role of a parent or a child).

It should be noted that the user interface unit 14 is a module configured to accept data input from the user through a keyboard, pointing device and the like, and carry out data output to the user through a display and the like, the communication processing unit 15 is a module configured to transmit/receive a message such as electronic mail and the like to/from the other computers 2, and the public key cryptographic processing unit 16 is a module configured to carry out encryption/decryption of data or putting of a digital signature and verification thereof.

Further, the process support tool 10 includes a database 50, and manages various information items such as member information 51, link information 52, affiliation permission information 53, utilization permission information 54, process 55, message 56 and the like by utilizing the database 50.

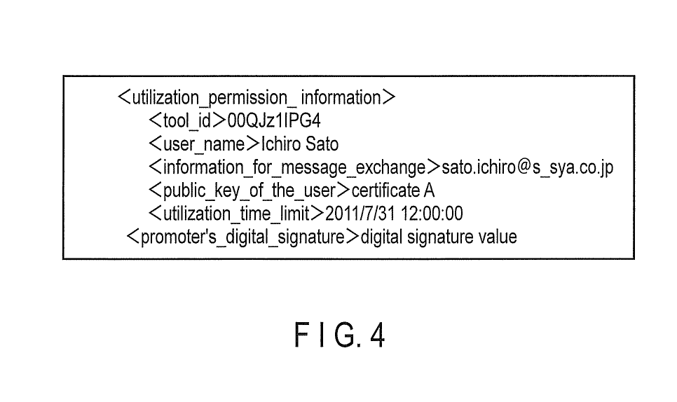

Acquisition of the utilization permission information 54 is carried out by, for example, a “utilization_permission_application” process provided by the promoter. An operation of the process is based on an operating principle of the process to be described later. The utilization permission information 54 acquired by the above process is managed in the database 50. A configuration example of the utilization permission information is shown in FIG. 4.

The utilization permission information 54 is created as text data described in, for example, Extensible Markup Language (XML), includes a “tool_id” uniquely assigned to the process support tool 10, “information_for_message_exchange” such as an electronic mail address or the like, and “public_key_of_the_user”, and can include, in addition to the above, a “user_name”, “usage_expiry_date” and the like. The promoter utilizes these information items as, for example, information for carrying out accounting management of users of the process support tools 10. The utilization permission information 54 is transmitted to the process support tool 10 with a digital signature of the promoter attached thereto. In this embodiment, it is assumed that the public key is treated in the form of a certificate issued by the certificate authority (CA) bureau. The promoter itself may issue the utilization permission information 54 in the form of a certificate as the CA bureau. Further, it is assumed hereinafter that all the verification processes of various data items using digital signatures including the verification of the utilization permission information 54 are executed by using the public key cryptographic processing unit 16. Each process support tool 10 identifies itself on the basis of managed information about the public key/secret key, and the tool ID/public key described in the utilization permission information 54.

Next, the fundamental principle of forming a group 100 and defining/processing a work flow by the cooperation of a plurality of process support tools 10 each of which has acquired the utilization permission information 54 in the above-mentioned manner will be described below.

When a group 100 is to be formed by users using the process support tools 10, a process support tool 10 of one of the users becomes a parent as described above. Process support tools other than the parent process support tool 10 acquire the affiliation permission information 53 from the parent process support tool 100. Acquisition of the affiliation permission information 53 is carried out by, for example, a “group_formation” process provided by the promoter. An operation of the process is based on an operating principle of the process to be described later.

First, a member file associated with this particular group 100 is read by the “group formation” process, and the group member management unit 11 creates member information 51 on the basis of the information of the member file.

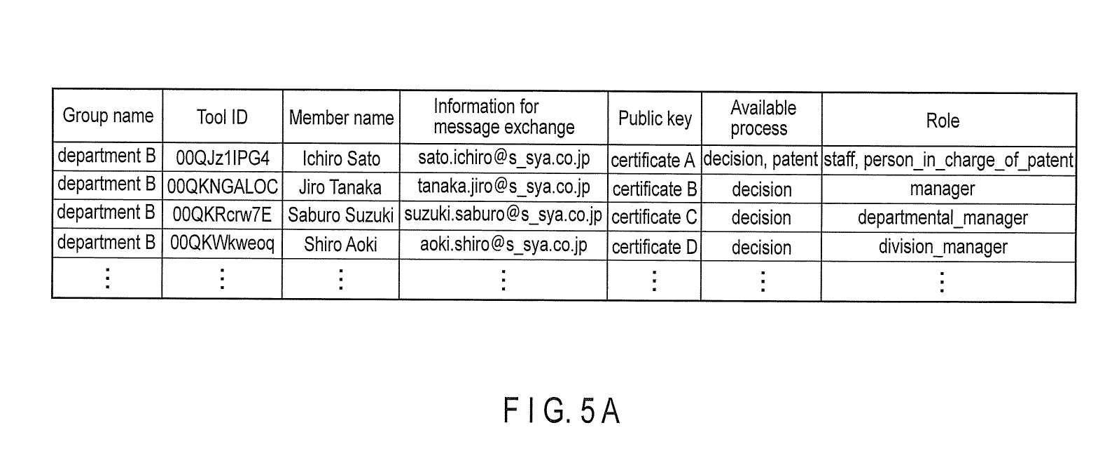

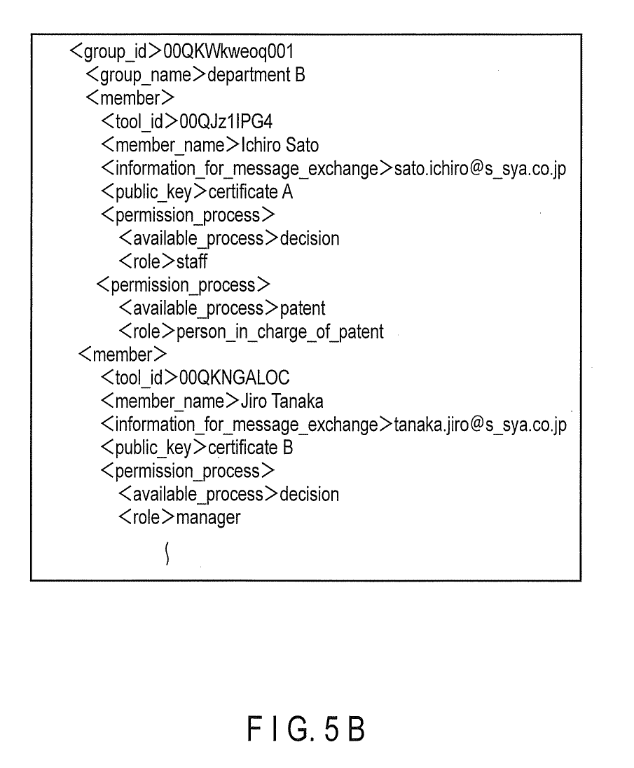

FIG. 5A is a view showing an example of a member file created by the user for the purpose of creation of the member information 51. On the other hand, FIG. 5B is a view showing an example of the member information 51.

The member file is created in the form of, for example, a worksheet of spreadsheet software. As shown in FIG. 5A, the member file includes values of a “tool_id” field, “group_name” field, “available_process” field and “role” field. When a “user_name”, “information_for_message_exchange” or “user's_public_key” different from the utilization permission information 54 is to be utilized in this group 100, these information items are also included in the member file. Here, it is assumed that the process means a series of work items (workflow) constituted of a plurality of steps, and each step in the process is called a task. Details of roles will be described later.

In the example of FIG. 5A, the name of group 100 to be formed is set to the “department B”. Further, a definition stating that the member “Ichiro Sato” can participate in the “decision” process and “patent” process, bears the role of a “staff” in the “decision” process, and bears the role of a “person_in_charge_of_patent” in the “patent” process is given. A definition stating that the member “Jiro Tanaka” can participate only in the “decision” process, the role in the “decision” process is a “manager”, further the members “Saburo Suzuki” and “Shiro Aoki” can also participate only in the “decision” process, and the roles in the “decision” process are the “departmental_manager” and “division_manager” is also given. Further, on the basis of the member file, the group member management unit 11 creates the member information 51 shown in FIG. 5B, and manages the created member information 51 in the database 50. The member information 51 is created as text data described in, for example, XML. Regarding the “group_id” in FIG. 5B, a unique value, for example, the “tool_id” of the parent user's process support tool 10+a serial number incremented each time this particular process support tool 10 forms a group 100 as a parent is assigned in order to avoid duplication among the plurality of groups 100.

It should be noted that when the member information 51 is created by the group member management unit 11 of this group (of the parent user's process support tool 10), in the other child user's process support tool 10, the utilization permission information 54 of its own is returned to the parent process support tool 10 in response to a request from the parent process support tool 10, and then the parent process support tool 10 confirms the contents of the returned utilization permission information 54 to carry out verification of the justifiability about the usage of the member or public key acquisition of a case where a public key is not included in the member file. It should be noted that there are not only the method such as the “group_formation” process in which the parent actively constitutes the member, but also a method in which the member information 51 is updated by a request from a user who wishes to be affiliated with the group by, for example, a “group_affiliation_application” process provided by the promoter.

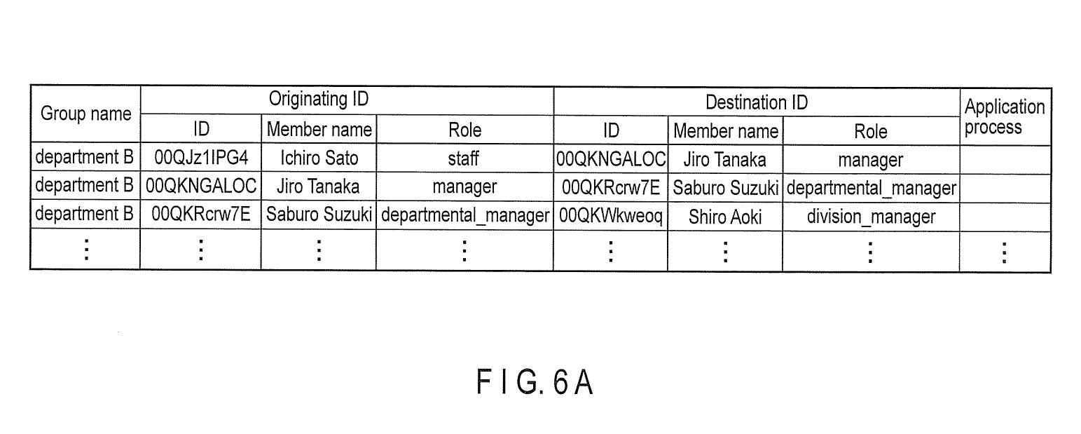

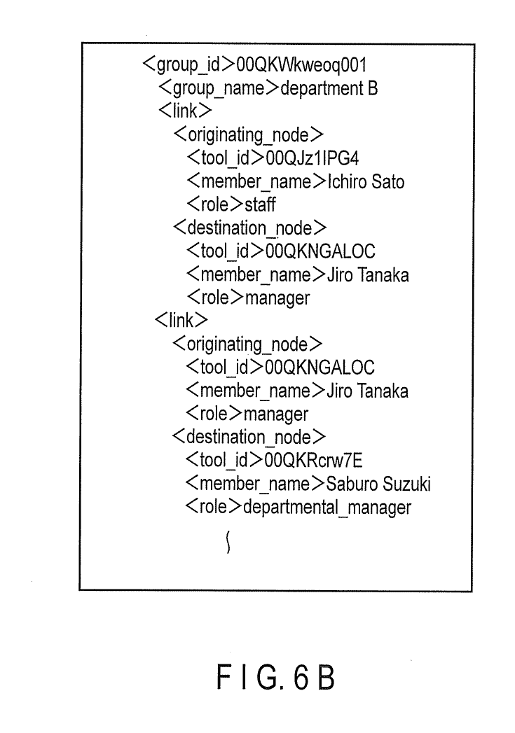

Subsequently, a link file associated with this particular group 100 is read by the “group_formation” process or the “group_affiliation_application” process, and the group member management unit 11 creates the link information 52 on the basis of information of the read link file. FIG. 6A is a view showing an example of the link file created by the user for the purpose of creation of the link information 52. On the other hand, FIG. 6B is a view showing an example of the link information 52.

The link file is created in the form of, for example, a worksheet of spreadsheet software. In the example of FIG. 6A, links between members (in group 100 to be formed) such as, the member “Ichiro Sato” (role: “staff”)→member “Jiro Tanaka” (role: “manager”)→member “Saburo Suzuki” (role “departmental_manager”)→member “Shiro Aoki” (role: “division_manager”) are defined. By the definition of this link file, for example, when a plurality of managers and departmental managers are present in group 100, if a process of a flow such as “staff”→“manager”→“departmental_manager” occurs at the member “Ichiro Sato”, “Ichiro Sato” being the origin, it is possible to appropriately circulate this process from the plurality of managers and departmental managers to the member “Jiro Tanaka”, and member “Saburo Suzuki”. It should be noted that when links to be applied differ depending on the process, the “application_process” column is also set to be filled in. Further, on the basis of this link file, the group member management unit 11 creates the link information 52 shown in FIG. 6B, and manages the created link information 52 in the database 50. The link information 52 is created as text data described in, for example, XML.

The member information 51 and link information 52 (hatched data items in FIG. 3) created by the group member management unit 11 in the manner described above are managed in the database 50 of the parent process support tool 10 which has formed this particular group 100. Accordingly, when a certain process support tool 10 is affiliated with n groups 100, bears the role of a parent in each of m groups 100 among the n groups 100, and carries out formation/management of these groups, m items of member information 51, and m items of link information 52 are respectively present in the database 50 of this particular process support tool 10.

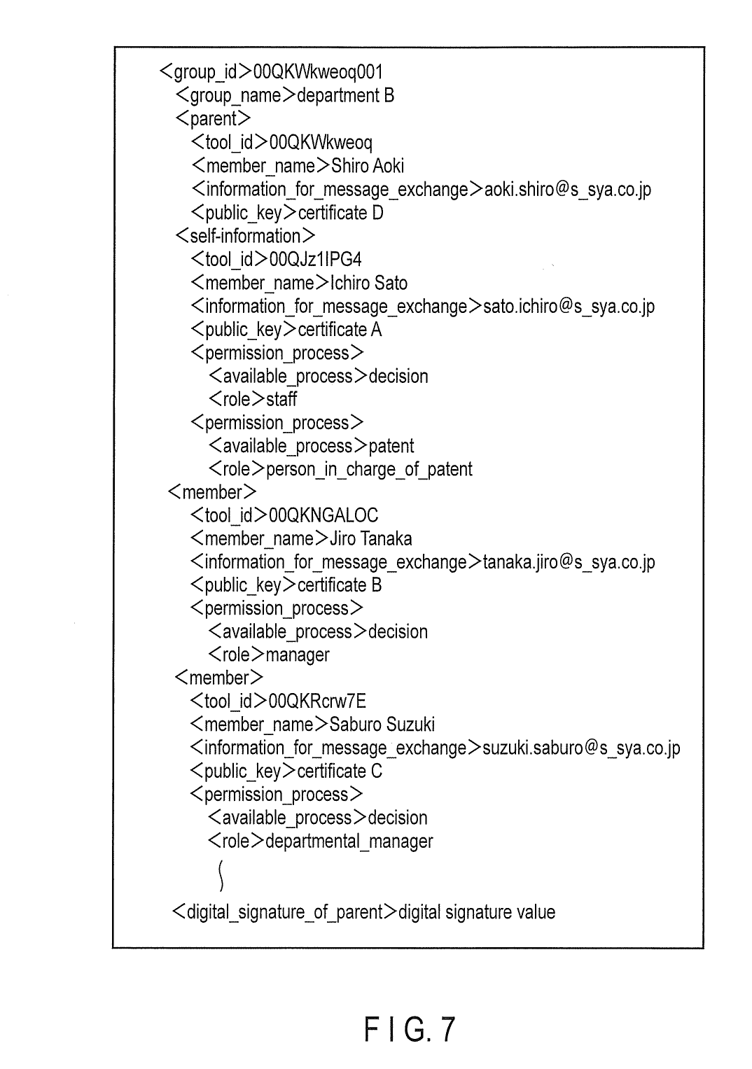

Furthermore, by the “group_formation” process or the “group_affiliation_application” process, the group member management unit 11 creates affiliation permission information 53 (including its own one) for each of the members affiliated with group 100 and distributes the created affiliation permission information 53 to the members, based on the member information 51 and the link information 52 created in the manner described above. A configuration example of the affiliation permission information 53 is shown in FIG. 7.

The affiliation permission information 53 shown in FIG. 7 is an example of the affiliation permission information 53 created with respect to the member “Ichiro Sato”. It should be noted that it is assumed that this particular group 100 is formed by the process support tool 10 of the member “Shiro Aoki”, the process support tool 10 being the parent of that group 100. Accordingly, the tool ID thereof “00QKWkweoq” (see FIG. 5A)+a serial number “001” is assigned as the group ID of the particular group 100.

The group member management unit 11 refers to the link information 52 for each of the members described in the member information 51 to thereby detect the other members having direct or indirect links with the particular members. Then, the group member management unit 11 creates data which includes the “parent (information about the parent itself)”, “self_information (information about the member)” and “member (information about the detected other member)”, and to which a digital signature covering these information items is attached as the affiliation permission information 53 for the member. The affiliation permission information 53 is managed in a database 50 of a process support tool 10 of each member of the distribution destination. The affiliation permission information 53 is created as text data described in, for example, XML.

According to the link information 52 shown in FIG. 6B, it can be seen that the member “Ichiro Sato” (directly) has a link with the member “Jiro Tanaka”, and then from the fact that the member “Jiro Tanaka” (directly) has a link with the member “Saburo Suzuki”, it can further be seen that the member “Ichiro Sato” (indirectly) has a link with “Saburo Suzuki”. As described above, by tracing the link information 52, it is possible to create the affiliation permission information 53 for the member “Ichiro Sato” as shown in FIG. 7. It should be noted that when the process to be applied is set in the link information, the “application_process” is set in the information about the associated member. In this affiliation permission information 53, a public key of the parent, and a digital signature of the parent are included, and hence it is possible to appropriately verify that the affiliation permission information 53 has not been falsified. When a certain process support tool 10 is affiliated with n groups 100, n items of affiliation permission information 53 are present in the database 50 of the process support tool 10 (irrespectively of the role of the parent or the child).

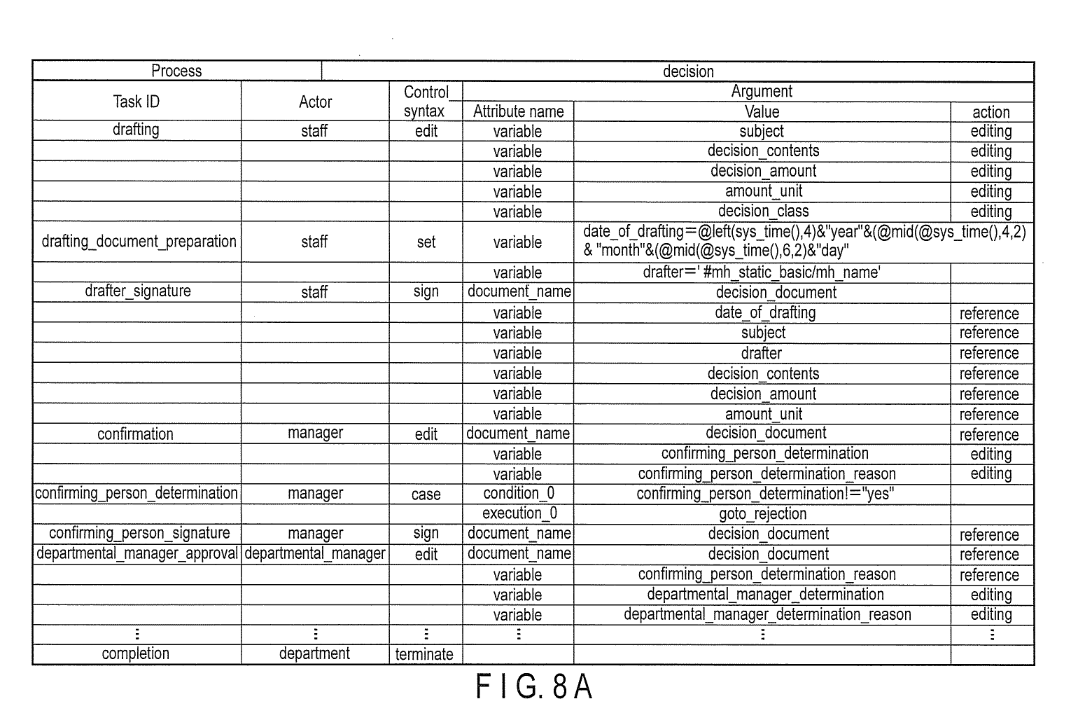

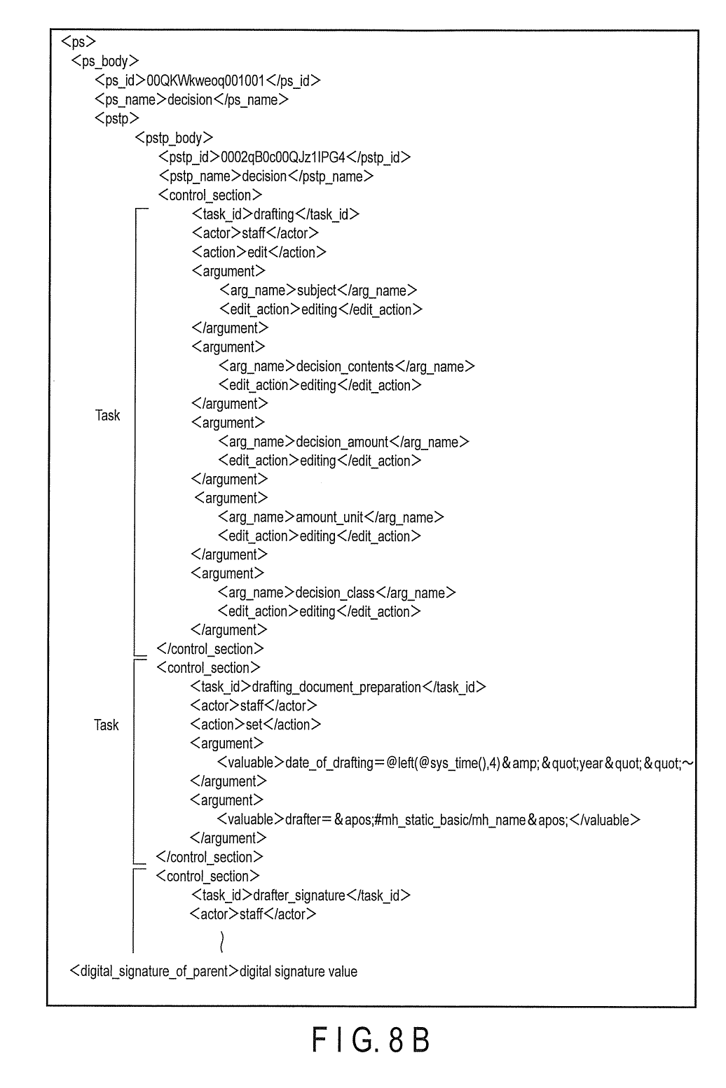

As a result of the above, the formation of group 100 based on the “group_formation” process or the “group_affiliation_application” process carried out by the group member management unit 11 is completed, and this time, the process support tool 10 bearing the role of the parent executes definition of the process 55 to be processed in group 100 by means of the process definition unit 12 on the basis of, for example, a “process_definition” process provided by the promoter. A configuration example of the process 55 will be described below with reference to FIG. 8A and FIG. 8B.

FIG. 8A is a view showing an example of a process file created by the user for the purpose of definition of the process 55. On the other hand, FIG. 8B is a view showing an example of the process 55 created by the process definition unit 12 on the basis of the process file.

As described previously, a process is constituted of a series of tasks, and processing contents of each task, a role of a member which should process each task, and processing order of the tasks are defined by the process file. In the example of FIG. 8A, the “decision” process is defined as a procedure of “drafting” task→“drafting document preparation” task→“drafter signature” task→“confirmation” task→ . . . “completion” task. Further, to give a description by taking the “drafting” task as an example, a definition stating that the person who is to process the “drafting” task is a member bearing the role of the “staff”, and the processing matter is editing of variables “subject”, “decision_contents”, “decision_amount”, “amount_unit”, and “decision_class” is given. That is, the member bearing the role of the “actor” field processes the tasks of the “task_id” field by executing the commands of the “control_syntax” field in accordance with the designation items of the “argument” field, whereby the matters to be processed are carried out in sequence.

The process file is created in the form of, for example, a worksheet of spreadsheet software. Further, on the basis of this process file, the process definition unit 12 creates a process 55 shown in FIG. 8B. At that time, a unique value, for example, the group ID (00QKWkeoq001)+a serial number (001) incremented each time the process 55 is created in group 100 is assigned to each process 55 as a process ID. Further, since a digital signature of the parent is included in each process, it is possible to appropriately verify that the process 55 is not falsified by using the public key of the parent included in the affiliation permission information 53. Each process 55 is created as text data described in, for example, XML.

It is made possible to acquire a process template defining a process having typical contents from the promoter web server 1 or the like, and a process ID and process name as group 100, and a digital signature given by the parent are imparted to the process template to give a definition as the process 55, whereby it is possible to save the time and labor for creation of the process of the parent.

Each process 55 is distributed at least to a process support tool 10 of a member in group 100 configured to process the process 55, and is managed in each database 50. Instead of the above, each process 55 may be managed in, for example, a common file server or the like accessible from process support tools 10 of all the members in group 100.

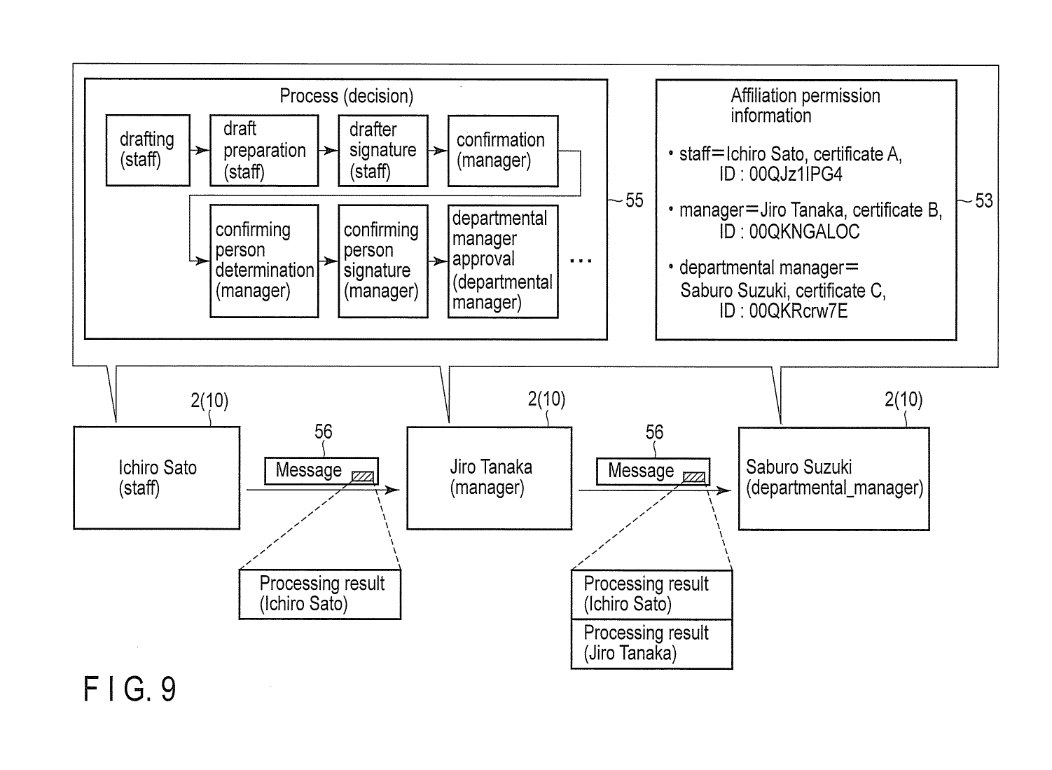

Next, in this workflow system in which group 100 is formed in the manner described above (by formation of the member information 51, link information 52, and affiliation permission information 53), and the process 55 is defined, through what procedure the process support tools 10 of the plurality of members affiliated with group 100 cooperate with each other to process the process 55 will be described below with reference to FIGS. 9 to 15.

FIG. 9 is a conceptual view for explaining the principle of processing in which a plurality of process support tools process the process 55 in cooperation with each other in this workflow system.

Processing of the process 55 in each process support tool 10 is executed by the task processing unit 13. Now, it is assumed that the member “Ichiro Sato” intends to write and present a decision document. What defines a series of work items (workflow) associated with the decision document is the “decision” process.

Thus, the member “Ichiro Sato” carries out an operation of selecting the “decision” process (from among a plurality of processes) by using the process support tool 10. In response to this operation, first, the task processing unit 13 verifies that the “decision” process managed as part of the process 55 is not falsified by using the affiliation permission information 53 (public key of the parent), and confirms that the member “Ichiro Sato” can start the “decision” process by checking that the “decision” process is described in the affiliation permission information 53 as the available process, and the role of the “staff” of the first “drafting” task is also described therein. When the justifiability could have been verified, and it could have been confirmed that the member “Ichiro Sato” can start the “decision” process, the task processing unit 13 creates a message 56, and executes the first “drafting” task. Thereafter, the message 56 circulates among the process support tools 10 each bearing the roles required to process the tasks defined by the processes 55. On each process support tool 10, the message 56 is managed in the database by the task processing unit 13 functioning also as the message management unit.

When the process 55 is started, i.e., when the message 56 is created, the task processing unit 13 stores the affiliation permission information 53 of its own in the message 56. In the affiliation permission information 53, public keys of the members present on the circulation path of the message 56 are included, and hence, after this, each member can appropriately carry out verification of various data items in the message 56 by using the affiliation permission information 53.

Although this “decision” process is processed by a flow of “drafting” task→“drafting_document_preparation” task→“drafter_signature” task, a definition stating that these tasks should be executed by the member of the role “staff” is given, and hence these tasks are successively executed by the process support tool 10 of the member “Ichiro Sato” who has started the “decision” process under the control of the task processing unit 13. Each time an objective task is processed, the task processing unit 13 adds a processing result thereof to the message 56, and attaches a digital signature thereto.

On the other hand, the definition states that the subsequent “confirmation” task should be executed by a member of the role “manager”. Then, the task processing unit 13 (of the process support tool 10 of the member “Ichiro Sato”) refers to the affiliation permission information 53 to recognize that the “manager” for the member “Ichiro Sato” is the member “Jiro Tanaka”, and transfers the message 56 to the process support tool 10 of the member “Jiro Tanaka” by using the “information_for_message_exchange” included in the affiliation permission information 53.

The task processing unit 13 (of the process support tool 10 of the member “Jiro Tanaka”) which has received the message 56 verifies one or more processing results which are added to the message 56, which are obtained theretofore, and to which the digital signature are attached, by using the public keys of the members of the preceding tasks included in the affiliation permission information 53 and, when the justifiability thereof is verified, starts the “confirmation” task of its own. Hereinafter, likewise, the processing result of the task executed by the member “Jiro Tanaka” is added to the inside of the message 56, then it is recognized that the “departmental_manager” for the member “Jiro Tanaka” is the member “Saburo Suzuki” by referring to the affiliation permission information 53 and, then the message 56 is transferred to the member “Saburo Suzuki”.

It should be noted that when the “decision” process is started by a member of another section or department, i.e., a member (of the role “staff”) whose “manager” or “departmental_manager” is not the member “Jiro Tanaka” or the member “Saburo Suzuki”, the “manager” and “departmental_manager” for the member are appropriately specified on the basis of the affiliation permission information 53 of the member, whereby the message 56 is transferred to the manager and departmental manager.

In each process support tool 10, the task processing unit 13 processes each task in accordance with the grammar previously defined as the control syntax. The control syntax enables, for example, the following setting items.
display of variable value for user, editing of variable by user, assignment into variable, calculation, character string handling
digital signature by user's secret key
constant definition, hierarchy definition of variable
time stamp (acquisition of time stamp of service provider for e-document [electronic document with digital signature])
write/read of data to/from file or database, storage of e-document in folder or database
conditional branching (including next task control), standby, repetition
creation of other messages (activation of other processes)

In cases other than the case where operation by the user such as editing of a variable value or the like is needed, automatic processing is carried out as is specified by the task. In, for example, FIG. 8A, the “drafter_signature” task is “sign”, a “decision_document” constituted of a “date_of_drafting”, “subject” and the like is prepared, then digital signing is carried out by using a secret key of the staff, however, actions corresponding to variables are all done by using “reference”, and only citing of a value set in the previous task is carried out, and hence these actions are carried out by automatic processing. It should be noted that when a variable is cited in the control syntax of the task, the task processing unit 13 tracks back the processing result information of the tasks obtained theretofore from the most recent processing result information, and regards the first detected set value in the processing result information as the value at that time point to thereby carry out processing and display.

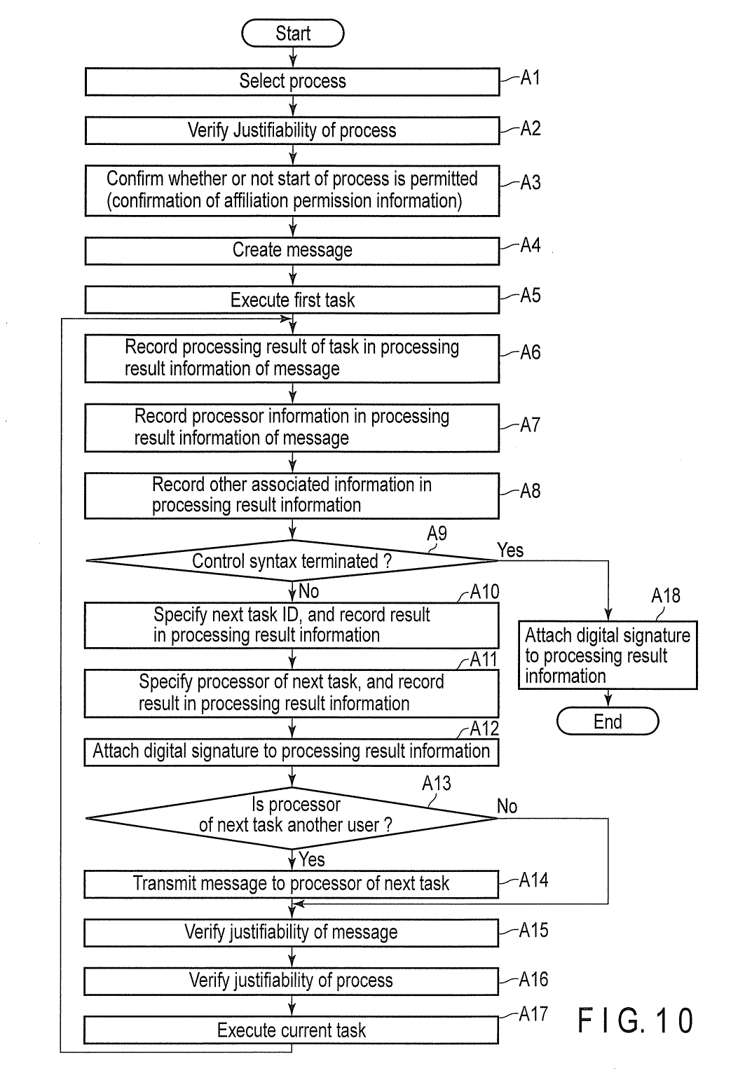

FIG. 10 is a flowchart showing an example of a processing procedure of the process 55 (message 56) in this workflow system.

First, under the control of a task processing unit 13 of one process support tool 10 affiliated with a certain group 100, selection of one process 55 defined in group 100 is carried out (step A1). When this selection is carried out, the task processing unit 13 verifies the justifiability of the process 55 on the basis of a digital signature of the parent attached to the process 55, and public key of the parent included in the affiliation permission information 53 (step A2), and furthermore confirms on the basis of the affiliation permission information 53 whether or not the process 55 can be started (step A3).

After completion of the verification of the justifiability of the process 55, and confirmation regarding whether or not the process 55 can be started, the task processing unit 13 creates a message 56 (step A4). The message 56 is created as text data described in, for example, XML, and a message ID, group ID (not necessary when it is included in the process ID), process ID, and affiliation permission information 53 of the process creator (first task processor) are included therein. The message ID is created at this point of time as a unique value in the entire system.

For example, the combination of the tool ID of the process support tool 10+creation time information+a serial number value incremented each time the message is created within the unit creation time is assigned thereto. Besides, the utilization permission information 54 of the process creator or the process itself may be included therein. The utilization permission information 54 is utilized for a temporary user processing process to be described later or the like.

Further, the task processing unit 13 starts processing of the first task defined in the process 55 (step A5).

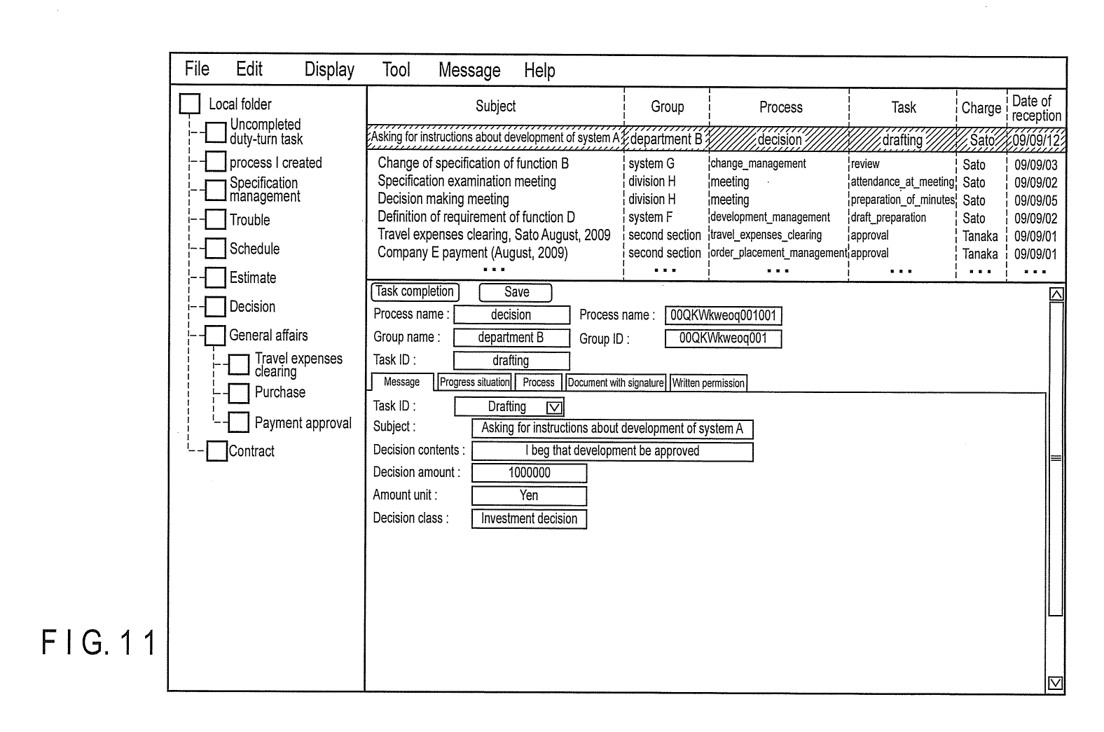

Assuming that a message 56 corresponding to the “decision” process exemplified by FIG. 8A and FIG. 8B has been created, the first task is the “drafting” task, and the control syntax thereof is “edit”, i.e., “editing”, and hence the task processing unit 13 presents, for example, a work screen shown in FIG. 11, and urges the user to input data of each item. As shown in FIG. 8A and FIG. 8B, the “drafting” task is configured to input a value to each of the variable “subject”, variable “decision_contents”, variable “decision_amount”, variable “amount_unit”, and variable “decision_class”, and hence the task processing unit 13 arranges the input area of these items on the work screen to present them. At this time, the task processing unit 13 uses the user interface unit 14.

When the processing of the task is completed, the task processing unit 13 first records the processing result (success/failure, etc.), input value on the work screen, operation processing result and the like in the message 56 as processing result information (step A6). Further, the task processing unit 13 records its own tool ID (processor information) in the message 56 as processing result information in the same manner (step A7). Furthermore, the task processing unit 13 records, for example, the task ending time and the like (other associated information) in the message 56 as processing result information in the same manner (Step A8).

Upon recording of the processing result information in the message 56, the task processing unit 13 checks whether or not the current task is the last task (“completion”: control syntax “terminate”) (step

A9). When it is not the last task (NO in step A9), the task processing unit 13 specifies the next task, and records the task ID thereof in the message 56 as the (next) processing result information (step A10). When the next task ID is not specified as the task processing result information, a task described in the next line of the current task in the process 55 is selected.

Further, the task processing unit 13 specifies the processor of the previously specified next task on the basis of the corresponding process 55 and affiliation permission information 53, and records the tool ID (processor information) thereof in the message 56 as the (next) processing result information (step A11). The next task processor is specified as a processing result of the task in some cases. If the person-in-charge information is not included in the affiliation permission information 53 in the message, the affiliation permission information 53 of the person in charge is added to the message 56 when the person in charge is on duty (for the purpose of verification of the digital signature for the processing result).

Further, the task processing unit 13 attaches a digital signature to a range of the record contents heretofore added to the message 56 (step A12).

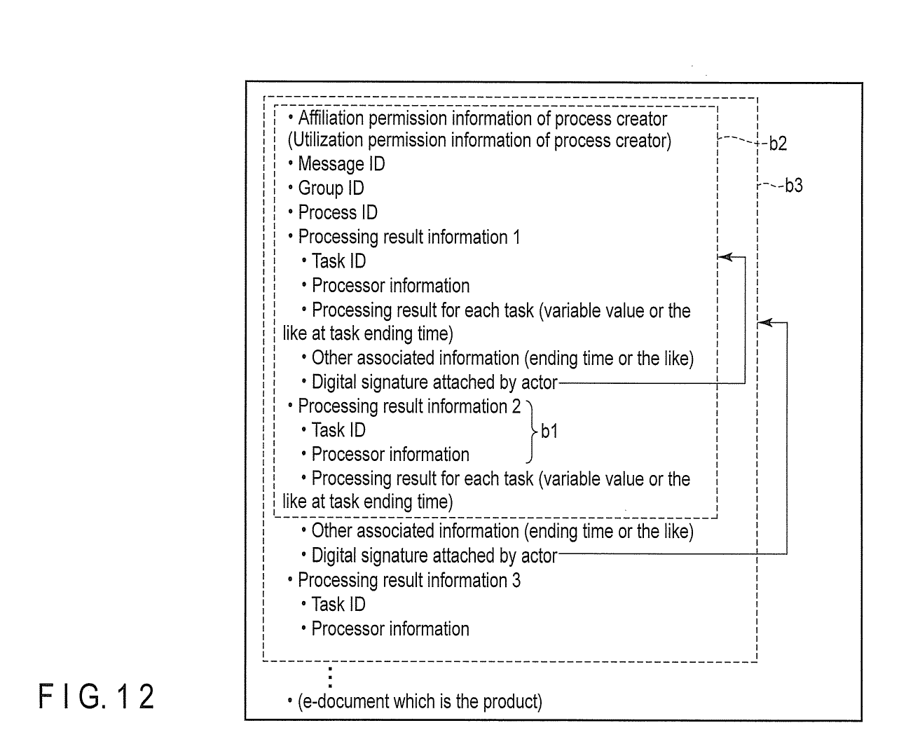

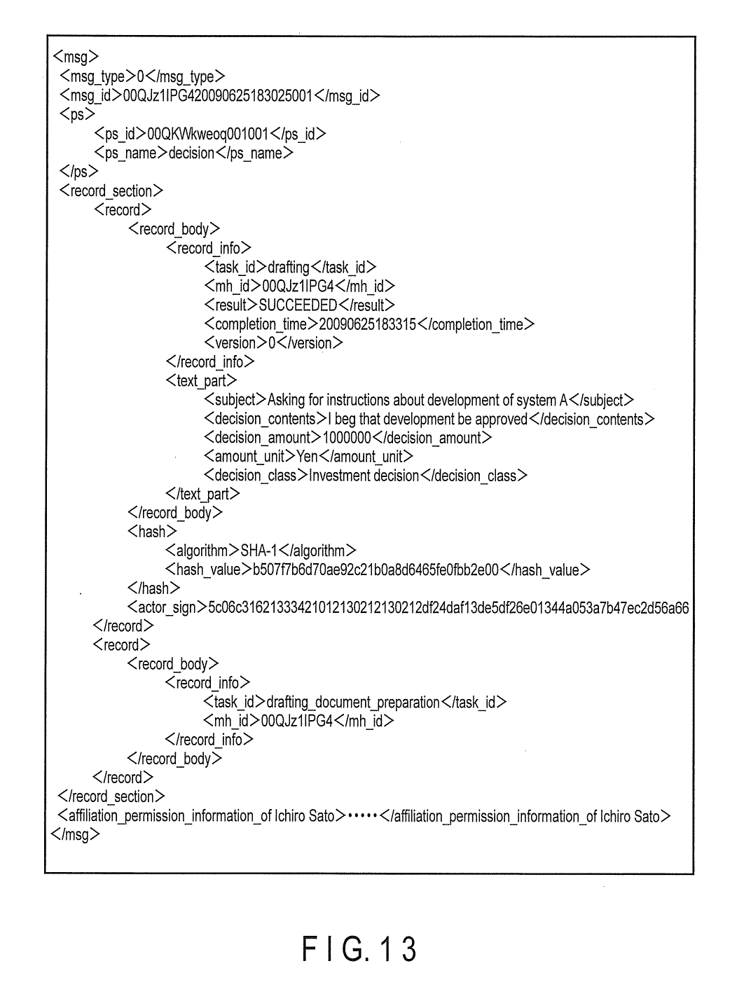

Here, a configuration of the message 56 to which the processing result information items are added by the task processing unit 13 of the process support tool 10 as described above will be described below by referring to FIG. 12 and FIG. 13.

FIG. 12 is a conceptual view for explaining an example of a procedure for adding processing result information to the message 56. The information in an area b1 is set by the previous task processor as the next task information when the previous task is completed. Further, an area b2 shows an example of a range at the time at which the first task processor attaches a digital signature, and area b3 shows an example of a range at the time at which the next task processor attaches a digital signature. On the other hand, FIG. 13 is a view showing an example of the message 56 to which the processing result information items are added in sequence through the procedure described above.

Next, the task processing unit 13 determines whether or not the processor of the previously specified next task is another user (step A13). Further, when the next task processor is another user (YES in step A13), the task processing unit 13 transmits the message 56 to the process support tool 10 of the other user on the basis of the affiliation permission information 53 (step A14).

On the other hand, in the process support tool 10 of the user who is the processor of the next task, the task processing unit 13 verifies the justifiability of the message 56 on the basis of the digital signatures attached by the successive processors until the previous task, and public keys of the successive processors in the period to the previous task included in the affiliation permission information 53 (step A15), and further verifies the justifiability of the process 55 corresponding to the message 56 on the basis of the digital signature of the parent attached to the process 55, and public key of the parent included in the affiliation permission information 53 (step A16). Further, after completion of the verification of the justifiability of the message 56, and that of the process 55 corresponding to the message 56, the task processing unit 13 starts processing of the current task added to the message 56 by the processor of the previous task (step A17).

Hereinafter, in the same manner as (the task processing unit 13 of) the processor of the previous task, the task processing unit 13 executes the processing from step A6, and executes addition of the processing result information to the message 56 and the like. Further, when the current task is the last task (YES in step A9), the task processing unit 13 attaches a digital signature to the processing result information, and terminates the processing associated with the message 56 (step A18).

The task processing unit 13 can present a list of the messages 56, processing result information of the messages 56 or progress situation to the user by means of the user interface unit 14.

In the message 56, an e-document is created as a product of the processing result of the process. In the case of the “decision” process shown in FIG. 8A, an e-document, i.e., the “decision_document” constituted of a “date_of_drafting”, “subject”, “drafter” and the like with a digital signature of Ichiro Sato in “sign” of the “drafter_signature” task is created in the place of “(e-document which is the product)” in FIG. 12. Further, in this “decision” process, the decision document to which the staff attaches a digital signature, and the manager, and departmental manager further add their digital signatures is stored in a folder designated in the task as a file to which a “subject” is named in the subsequent task.

All the information items (utilization permission information 54, affiliation permission information 53, process 55, message 56) to be circulated are verified to check whether or not they are falsified by digital signatures, and information having no justifiable signature or unjust information is not processed, and an error message is notified to the user.

Incidentally, as shown in FIG. 2, in this workflow system, it is possible for one process support tool 10 to be affiliated with a plurality of groups 100. Then, in this workflow system, cooperation between processes including different groups 100 is realized by message cooperation or creation of other messages.

That is, in this workflow system, control syntax configured to enable the task processing unit 13 to carry out starting of the process 55 (creation of the message 56) as a task in the process 55 (within its own permitted scope) is provided. Further, it is also possible to set the control syntax for a message 56 in such a manner that another message 56 is searched for or arrival of the another message 56 is monitored on the basis of the group ID, process ID, task ID, message ID, value of a variable and the like by the message, and when search or arrival is detected, specific processing is carried out.

It is also possible to describe the control syntax in such a manner that when the message 56 to be detected is a task waiting for editing by the user, substitution of the task into the variable to be edited is automatically processed.

Further, it is also possible to set the control syntax in such a manner that a variable to be edited is fractionalized with respect to the message 56 to be detected.

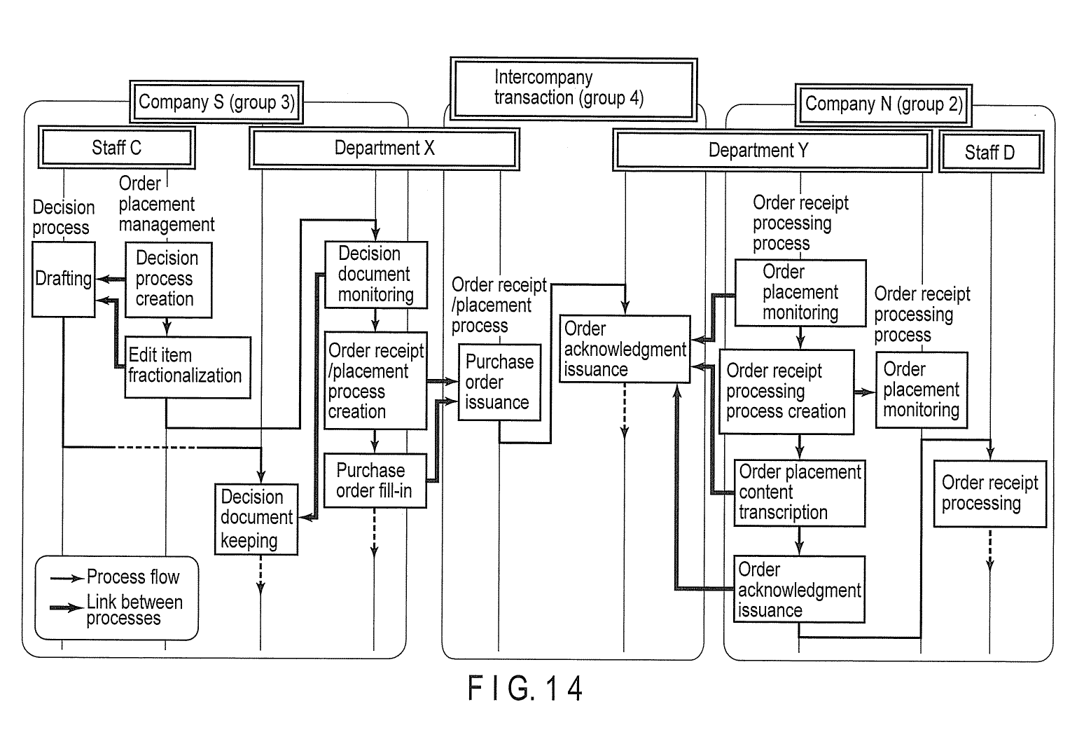

In the example shown in FIG. 1, the department X server of company S is affiliated with group 3, and the department Y server of company N is affiliated with group 2 and, at the same time, each of these servers is also affiliated with group 4. An example in which, under such circumstances, the process 55 of group 4, the process 55 of group 3, and the process 55 of group 2 are made to cooperate with each other on the servers affiliated with the three groups 100 will be described below by referring to FIG. 14.

First, it is assumed that an “order_receipt/placement” process is defined in group 4 constituted of company S (department X), and company N (department Y). In this “order_receipt/placement” process, although persons of each company can directly input data to edit items with respect to the process support tool 10 of department X, and process support tool 10 of department Y to advance the task, unique processes are made to cooperate with each other in each company for improvement in reduction of places requiring manpower. That is, in company S, the “order_placement_management” process for order placement, and the “decision” process are made to cooperate with each other in group 3, and in company N, the “order_receipt_processing” process is made to cooperate with in group 2. As a result, processes from the order placement decision drafting task in company S to the “order_receipt_processing” process in company N through the “order_receipt/placement” process between the companies are made to cooperate with each other, with the groups 100 being connected to each other.

In this case, department X of company S bears the role of managing matters to be decided for order placement (in company S) in group 3, and in connection with this, bears the role of issuing a purchase order (to company N) in group 4. On the other hand, department Y of company N bears the role of receiving the purchase order (from company S) in group 4, and in connection with this, bears the role of starting the “order_receipt_processing” process (in company N) in group 2.

First, when the staff C of company S starts the “order_placement_management” process, the first “decision_process_creation” task starts the “decision” process. The above is carried out on the premise that permission of starting of the “decision” process by the staff C is described in the affiliation permission information 53.

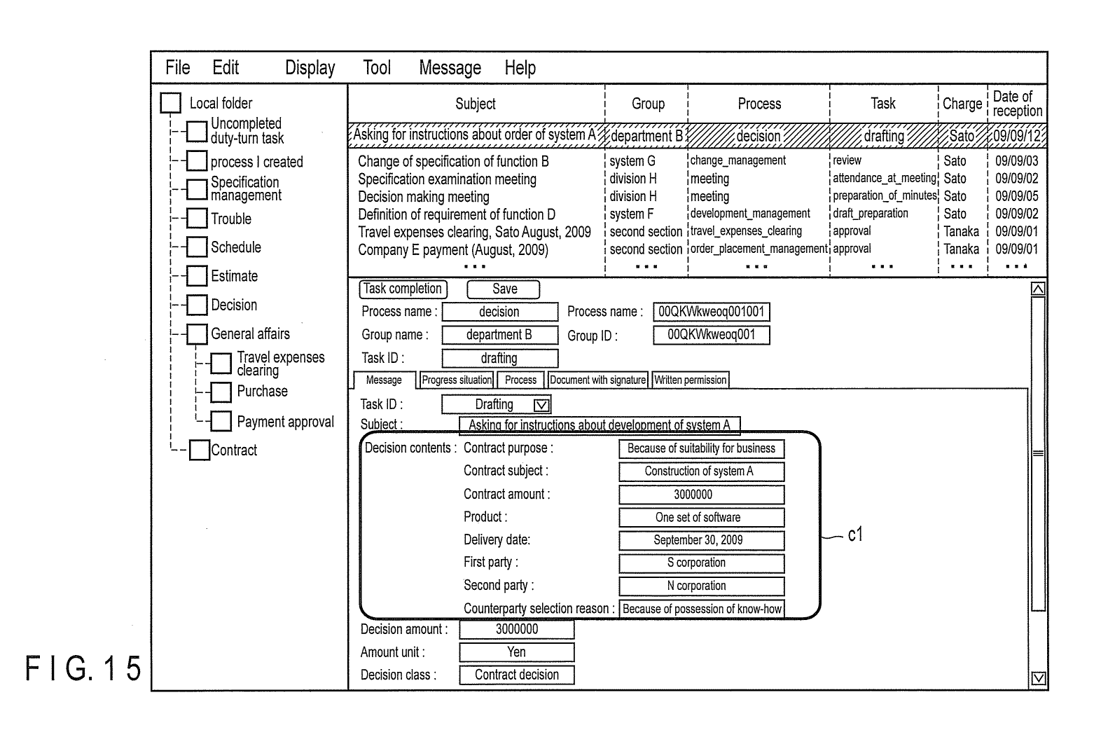

Next, the user editing item “decision_contents” in the “drafting” task of the “decision” process are fractionalized by the “edit_item_fractionalization” task into the “contract_purpose”, “contract_subject”, “contract_amount”, “product”, “delivery_date”, “first_party”, “second_party”, and “counterparty_selection_reason”. An example of the drafting screen of the “decision” process obtained after this processing is as shown in FIG. 15, and despite the fact that the above process and task are identical to the process and task of FIG. 11, the above “decision_contents” are fractionalized (c1 of FIG. 15).

As described above, by making the branch processes such as the “order_placement_management” cooperate with each other without changing the fundamental process itself, it is possible to improve the entire process.

Thereafter, in the “order_placement_management” process, the decision is monitored by department X for its being approved in the “decision_document_monitoring” task by using the message ID and variable value in the decision document as a key. When the decision approval is detected, the “order_receipt/placement” process is created in the “order_receipt/placement_process_creation” task, and necessary items are transcribed from the decision document to the purchase order in the “purchase_order_fill-in” task. It should be noted that in FIG. 14, exception handling such as disposal of a case where the decision document is not detected for a predetermined time or the like is entirely omitted.

The “order_receipt/placement” process is automatically created in the “order_placement_management” process, and all the necessary items for editing are automatically set to the first task “purchase_order_issuance” task by the “purchase_order_fill-in” task, whereby the above task is completed, and is transferred to department Y of company N as the “order_acknowledgment_issuance” task.

In department Y of company N, the previously started “order_receipt_processing” process monitors arrival of the “order_receipt/placement” process in the “order_placement_monitoring” task, and when the arrival is detected, another “order_receipt_processing” process is started for the subsequent monitoring of the “order_receipt/placement” process by the “order_receipt_processing_process_creation” task. Then, the former “order_receipt_processing” process itself acquires necessary information from the purchase order and stores the acquired information in the variable in the next “order_placement_content_transcription” task, and then, in the “order_acknowledgment_issuance” task, sets necessary edit items to the “order_acknowledgment_issuance” task of the “order_receipt/placement” process of which it is in charge, and proceeds to the “order_receipt_processing” task.

It should be noted that in the above-mentioned flow, in company N, an “order_receipt_processing” process is not created in the “order_receipt/placement” process, arrival of the “order_receipt/placement” process is monitored, and when the arrival is detected, the “order_receipt_processing” process is made to flow. This is, however, due to the premise that the “order_receipt/placement” process is utilized not only by company N and company S, but also by many other companies, and the specification cannot be changed. Even under such circumstances, it is made possible to make the “order_receipt_processing” which is the branch process cooperate with the “order_receipt/placement” process which is the fundamental process, and improve the entire process.

The mechanism of the process cooperation will be described below. Regarding the message 56 created by the task for which it is described that the task should create a message, and message 56 detected on the condition set in the control syntax, their message IDs are recorded in the processing result information as target messages, and they are treated as target messages when the task control is carried out until new target messages are detected in the subsequent task or until the processor changes. Regarding the target message, a plurality of target messages such as a <target message 1>, and <target message 2> may be treated.

Designation, for example, a “target_message_1 (variable 1)” in the control syntax enables substitution processing to be carried out in the same manner as the case of a variable in the own process 55. It should be noted that substitution processing is enabled in the case of a task in which the target message is waiting for user editing.

When a message is made a target of the other message 56, and values are set to all the necessary items, whether the task is to be completed immediately after the setting of the values or the completion requires active declaration of intention of the user in order to leave room for reediting by the user is controlled by, for example, description in the control syntax of the process 55.

When the task in which it is set in the control syntax that the variable to be edited should be fractionalized is executed, definition information of the variable which are to be fractionalized (“decision_contents” in the example of FIG. 15), and child variables (“contract_purpose”, “contract_subject” and the like in the example of FIG. 15) is recorded in the processing result information of the task at that time point on the target message side and, in the subsequent tasks, the fractionalized child variables are handled when the user is urged to edit or set information is displayed.

On the detected target message side, the message ID of the detection side and “fired” flag are set in the message, and control is carried out in such a manner that re-firing is not carried out, i.e., control is carried out in such a manner that the target message is never handled as a target message again.

A firing class is set in the control syntax of the process 55 on the detection side, and the firing class is recorded as a “fired” flag, whereby re-firing is not carried out for the particular task of this particular process 55, but it is also possible for the task to receive firing from a different process 55 or a different task. Further, it is also possible to specify that re-firing can be repeatedly carried out without setting the “fired” flag.

It should be noted that regarding the management of the target message on the detection side, and management of the firing origin message ID, and “fired” flag on the detected target message side, it is sufficient if these information items are managed by only the user on duty, and hence these information items may not be recorded in the message, but may be separately managed in the process support tool 10 as annexed information for message management.

As described above, in this workflow system, a person in charge of a task manages the task by himself or by herself as a message, and hence it is possible for the person to carry out improvement by process cooperation at the person's own discretion within a range of which the person takes charge without making adjustment to the system administrator which has been necessary in the current general server-type workflow system.

For example, a group is formed by a person who is the parent, and a member taking partial charge of the work, and a process for realizing a task of which the person takes charge is newly defined, and is made to cooperate with the task, whereby it is possible to realize fractionalization and delegation of the task. As a result, by stratifying and defining the process to adjust the process to the actual organization structure or roles, and making the stratified process cooperate with each other, in such a manner that the head office defines the fundamental process, a division additionally defines branch processes in accordance with the business contents and state of affairs in the country in which the business is developed, and further additionally defines leaf processes in accordance with the handled business contents or the individual abilities/skills of the persons in charge, whereby it is possible to form an optimum process as a whole.

Local process improvements are carried out by specific persons in charge or departments, a process is propagated, if it is a good one, successively to the adjacent sections and departments to be employed, and eventually, it becomes possible to incorporate a flow of “intention of incorporating the process into the standard process of the division” or “intention of incorporating the process into the whole company process” into the daily operations. As a result, it is possible to evolve the process in accordance with the environmental changes.

Further, in this workflow system, by realizing the workflow system in the form of the P2P type, it is possible for the persons who wish to be linked to each other to form a group at their discretion, define processes, and make the processes to cooperate with each other. The members who wish to be linked to each other can be successively linked to each other, and hence it can also be considered that the system has infinite capacity as a whole, and infinite process cooperation is enabled.

Furthermore, in this workflow system, it is also possible to create a processing result or product of the process as an e-document, and hence confirmation of evidences/traces is made easy, and process improvement is made remarkably easy. Further, stratification of evidences/traces, and circulation with successive changes in position are also enabled, and it is made possible to electronically realize, in the same form, processes such as transfer, impress, safekeeping and the like which have hitherto been carried out in the actual world by using paper in such a manner that a written application with a written guarantee issued by another person attached thereto is presented.

It should be noted that this workflow system is not limited to the contents described in the aforementioned embodiment, and can be variously modified.

In an environment in which in case of necessity, a necessary member's public key can easily be acquired by utilization of a directory server or the like, retention of the public key of the member in the member information 51 or in the affiliation permission information 53 is not indispensable. The retention of the public key may be determined according to which one of the message size and the message processing time is prioritized.

By transmission/reception of the control message in addition to the message 56, message delivery confirmation, progress notification, user control information transmission (process interruption, restoration and the like) and the like are enabled.

In message transmission, it is also possible to employ, in addition to a system in which all the information in the message 56 is transmitted, a system in which the message 56 main body itself is managed in a common folder or a database of a server accessible from associated members, and only a duty member notification including the storage position and message ID is transmitted as a control message.

It is also possible to set the same “work_class” in a plurality of similar processes 55, and set permission processes in units of “work_class” in the affiliation permission information 53.

Further, a generation number and validity period information may be included in each of the affiliation permission information 53 and process 55. When an update occurs in the information, the generation number is incremented. In the case of a reservation change, two versions of information, i.e., an edition obtained by adding the “ending_period” to the current information, and an edition of the latest information (beginning period is specified therein) are distributed.

Further, it is also possible to define a process in which anyone of group members without permission in the affiliation permission information 53 can create a process or a temporary user processing process in which a user other than the group members can take charge of process-creation or a task. In that case, in the processing of the corresponding task, a role in the process 55 is assigned to the member as the need arises. In the case of a user other than the members, the utilization permission information 54 is attached to the message 56 in place of the affiliation permission information 53. Because, this enables public key information for verification of a signature to be added to the processing result information to circulate. In the case of an environment in which in case of necessity, a necessary user's public key can be easily acquired by utilization of a directory server or the like, or in the case where a user's public key is not necessary, attachment of the utilization permission information 54 is not indispensable. It is also possible to define a process requiring no signature attached to the processing result.

It is also possible to set a tool ID of a specific process support tool 10 in place of a role in defining of a process.

A plurality of users in the organization can log in the process support tool 10 for use in the organization such as department X in FIG. 1. Normally, a maximum of one person is given the execute authority to carry out the task, and other users can carry out only reference. When a user given only the reference right needs to carry out work, the user carries out the work by using the user's own process support tool 10, and utilizes the result by defining processes cooperating with each other, whereby it is possible to appropriately keep the internal control.

What is claimed is:

1. A workflow system for processing a process constituted of a plurality of tasks in sequence by a plurality of workflow support modules which are incorporated in one or more computers and to each of which at least one of the plurality of tasks is assigned,
each of the plurality of workflow support modules comprising:
a group creation unit configured to create a group while defining a role of each of the plurality of workflow support modules to be affiliated with the group as members;
a process definition unit configured to define a process constituted of a plurality of tasks while designating roles of members to be in charge of the tasks; and
a process processing unit configured to process tasks in the process defined by the process definition unit, and to transfer a message to a workflow support module in which a role to be in charge of the next task is defined, the message including information indicating a processing result and a progress situation of each task concerning the process,
wherein the group creation unit is capable of creating a new group in a state where a workflow support module thereof is affiliated with an existing group and creating a new group with which another workflow support module affiliated with an existing group as a member is affiliated as a member,
thereby processing the process defined by the process definition unit by transferring a message associated with the process from one to the other in sequence among the plurality of workflow support modules in the group created by the group creation unit, and being capable of making a plurality of processes in a group cooperate with each other via one workflow support module and making processes of different groups cooperate with each other via a workflow support module affiliated with a plurality of groups in an overlapping manner.

2. The workflow system according to claim 1, wherein:
the group creation unit is further configured to create, for each of members affiliated with a group, affiliation information defining an operable range of the member, the operable range being associated with processing of a process in the group, and linkage of the member with the other associated member, and to provide the created affiliation information to each of the other workflow support modules in the group with which the workflow support module are affiliated as members; and
the process processing unit is further configured to determine whether or not processing of the task in the process can be executed based on the affiliation information, and to specify a transfer destination of the message.

3. The workflow system according to claim 2, wherein the process processing unit is further configured to add information indicating a processing result and progress information of each task to the message.

4. The workflow system according to claim 3, wherein:
the process definition unit is further configured to provide information associated with a defined process to each of other workflow support modules in a group with which each of the other workflow support modules have been affiliated as members by the group creation unit; and
the process processing unit is further configured to process the task in the process based on the information associated with the process.

5. The workflow system according to claim 2, wherein:
the process definition unit is further configured to provide information associated with a defined process to each of other workflow support modules in a group with which each of the other workflow support modules have been affiliated as members by the group creation unit; and
the process processing unit is further configured to process the task in the process based on the information associated with the process.

6. The workflow system according to claim 1, wherein the process processing unit is further configured to add information indicating a processing result and progress information of each task to the message.

7. The workflow system according to claim 6, wherein:
the process definition unit is further configured to provide information associated with a defined process to each of other workflow support modules in a group with which each of the other workflow support modules have been affiliated as members by the group creation unit; and
the process processing unit is further configured to process the task in the process based on the information associated with the process.

8. The workflow system according to claim 1, wherein:
the process definition unit is further configured to provide information associated with a defined process to each of other workflow support modules in a group with which each of the other workflow support modules have been affiliated as members by the group creation unit; and
the process processing unit is further configured to process the task in the process based on the information associated with the process.

9. The workflow system according to claim 1, wherein the process definition unit is capable of defining a process including a task for creating a different process in order to create a second process as processing of a task in a first process on one workflow support module.

10. The workflow system according to claim 1, wherein the process definition unit is capable of defining a process including a task for detecting a message associated with a different process in order to execute processing to be executed in a second process as processing of a task in a first process on behalf of the second process on one workflow support module and executing processing for the detected message.

11. The workflow system according to claim 1, wherein the process processing unit is further configured to attach a processing result or a product of the process to the message as an electronic document to which a digital signature is attached.

12. The workflow system according to claim 3, wherein each of the plurality of workflow support module further comprises a falsification countermeasure unit configured to attach a digital signature to at least one of the affiliation information, the information associated with the process and the information indicating a processing result and progress information of each task to be added to the message or to verify that these information items received from another workflow support module are not falsified by use of digital signatures attached to these information items.

13. The workflow system according to claim 6, wherein each of the plurality of workflow support module further comprises a falsification countermeasure unit configured to attach a digital signature to at least one of the affiliation information, the information associated with the process and the information indicating a processing result and progress information of each task to be added to the message or to verify that these information items received from another workflow support module are not falsified by use of digital signatures attached to these information items.

14. An information processing apparatus which processes a process constituted of a plurality of tasks in cooperation with other information processing apparatuses connected thereto via a network, comprising:
a group creation unit configured to create a group while defining a role of each of the information processing apparatuses to be affiliated with the group as members;
a process definition unit configured to define a process constituted of a plurality of tasks while designating roles of members to be in charge of the tasks; and
a process processing unit configured to process tasks in the process defined by the process definition unit, and to transfer a message to an information processing apparatus in which a role to be in charge of the next task is defined, the message including information indicating a processing result and a progress situation of each task concerning the process,
wherein the group creation unit is capable of creating a new group in a state where the information processing apparatus is affiliated with an existing group and creating a new group with which another information processing apparatus affiliated with an existing group as a member is affiliated as a member.

15. A non-transitory computer-readable having stored thereon a computer program which is executable by a computer which processes a process constituted of a plurality of tasks in cooperation with other computer connected thereto via a network, the computer program controlling the computer to function as:
a group creation unit configured to create a group while defining a role of each of the computers to be affiliated with the group as members;
a process definition unit configured to defining a process constituted of a plurality of tasks while designating roles of members to be in charge of the tasks; and
a process processing unit configured to process tasks in the process defined by the process definition unit, and to transfer a message to a computer in which a role to be in charge of the next task is defined, the message including information indicating a processing result and a progress situation of each task concerning the process,
wherein the group creation unit is capable of creating a new group in a state where the computer is affiliated with an existing group and creating a new group with which another computer affiliated with an existing group as a member is affiliated as a member.
